(19) United States
(12) Patent Application Publication
(10) Pub. No.: US 2026/0297378 A1
(43) Pub. Date: Oct. 1, 2026

(54) MODIFIED CERIUM OXIDE POLISHING SOLUTION FOR SHALLOW TRENCH ISOLATION AND PREPARATION METHOD THEREOF

(71) Applicant: Inner Mongolia University, Inner Mongolia (CN)

(72) Inventors: Hui SHEN, Inner Mongolia (CN); Bo GAO, Inner Mongolia (CN); Simin LI, Inner Mongolia (CN)

(21) Appl. No.: 19/345,263

(22) Filed: Sep. 30, 2025

(30) Foreign Application Priority Data
Mar. 28, 2025 (CN) 202510378951.0

(51) Int. Cl. C09G 1/02; C01F 17/235; C09C 3/08; C09K 3/14

(52) U.S. Cl. CPC C09G 1/02; C01F 17/235; C09C 3/08; C09K 3/1436; C01P 2002/72; C01P 2002/82; C01P 2004/03

(57) ABSTRACT

Provided are a modified cerium oxide polishing solution for shallow trench isolation and a preparation method thereof. The modified cerium oxide polishing solution is mainly prepared from, in percentages by mass, the following raw materials: 2% to 5% of a modified cerium oxide abrasive; and 95% to 98% of deionized water, where the modified cerium oxide abrasive includes a cerium oxide abrasive and a sulfonic acid ligand; and the sulfonic acid ligand is at least one selected from the group consisting of L-camphorsulfonic acid, o-toluenesulfonic acid, p-toluenesulfonic acid, and cyclohexane-2-sulfonic acid.

### CROSS REFERENCE TO RELATED APPLICATION

This patent application claims the benefit and priority of Chinese Patent Application No. 202510378951.0 filed with the China National Intellectual Property Administration on Mar. 28, 2025, the disclosure of which is incorporated by reference herein in its entirety as part of the present application.

### TECHNICAL FIELD

The present disclosure belongs to the technical field of rare earth materials, and in particular relates to a modified cerium oxide polishing solution for shallow trench isolation and a preparation method thereof.

### BACKGROUND

With the downscaling of semiconductor device fabrication processes to 3 nm and sub-3 nm node, the requirements for process accuracy and material compatibility in integrated circuit (IC) manufacturing have reached unparalleled heights. In this context, technical innovations in chemical mechanical polishing (CMP) and shallow trench isolation (STI), as critical process steps in chip manufacturing, become factors directly influencing device performance, yield rate, and cost control. The CMP technology achieves global or local planarization of wafer surfaces through the synergistic effect of mechanical and chemical actions, providing a uniform substrate for subsequent processes such as lithography and metal wiring. The STI technology forms insulating trench isolation between devices to prevent leakage current and enhance device reliability, playing a pivotal role in three-dimensional architectures such as FinFETs and GAA transistors.

However, conventional polishing solutions used in the STI technology tend to introduce nanoscale scratches, increased surface roughness, and lattice defects on silicon wafers due to the synergistic effect of mechanical stress and chemical corrosion during polishing. Furthermore, both silicon nitride and silicon oxide on the surface of the silicon wafers are removed during the polishing process, adversely affecting the performance of the silicon wafer. Therefore, developing a polishing solution that can control the removal rates of the silicon oxide layer and the silicon nitride layer and exhibits an improved selectivity ratio has become a critical research focus. In view of this, the present disclosure is proposed.

### SUMMARY

A first object of the present disclosure is to provide a modified cerium oxide polishing solution for shallow trench isolation. The modified cerium oxide polishing solution includes cerium oxide modified with a sulfonic acid ligand, and the cerium oxide modified with the sulfonic acid ligand can excellently protect the silicon nitride in the silicon wafer during the polishing process and allow the silicon nitride to retain as much as possible in the silicon wafer while the silicon oxide contained in the silicon wafer is removed, thus enabling the modified cerium oxide polishing solution to have an improved selectivity ratio of a silicon oxide layer to a silicon nitride layer. In addition, the introduction of the sulfonic acid ligand can enhance the dispersion of cerium oxide particles in the solution, so that the modified cerium oxide polishing solution without adding a stabilizer can prevent agglomeration and thus ensure the uniform distribution of the modified cerium oxide polishing solution and improve the polishing effect.

A second object of the present disclosure is to provide a method for preparing the modified cerium oxide polishing solution for the shallow trench isolation as described above. The modified cerium oxide polishing solution prepared by the method exhibits high stability and is suitable for the polishing treatment of high-precision elements such as semiconductors or optical elements. Furthermore, the preparation process in the method is straightforward and reduces the use of hazardous chemicals simultaneously, thereby minimizing environmental pollution.

To achieve the above objects of the present disclosure, the present disclosure provides the following technical solutions.

The present disclosure provides a modified cerium oxide polishing solution for shallow trench isolation, mainly being prepared from, in percentages by mass, the following raw materials:
2% to 5% of a modified cerium oxide abrasive; and
95% to 98% of deionized water; where
the modified cerium oxide abrasive includes a cerium oxide abrasive and a sulfonic acid ligand; and
the sulfonic acid ligand is at least one selected from the group consisting of L-camphorsulfonic acid, o-toluenesulfonic acid, p-toluenesulfonic acid, and cyclohexane-2-sulfonic acid.

In the present disclosure, the cerium oxide is modified by introducing a sulfonic acid ligand. The sulfonic acid ligand is adsorbed onto the surface of the cerium oxide by electrostatic action, so as to effectively change the surface properties of cerium oxide. The cerium oxide modified with a sulfonic acid ligand can achieve precise adjustment and control of CMP polishing performance, and the introduction of the sulfonic acid ligand as a functional ligand into cerium oxide can enhance the dispersion of the cerium oxide particles in the solution and prevent aggregation, thereby enabling the uniform distribution of the prepared polishing solution and thus improving the polishing effect. Furthermore, the introduction of the sulfonic acid ligand not only improves the chemical stability of the polishing solution but also prolongs the service life of the polishing solution, and the modified cerium oxide particles exhibit increased surface activity, significantly improving the polishing efficiency and quality. In addition, the introduction of the sulfonic acid ligand can significantly increase the dissolution rate of silicon oxide, promoting efficient removal of the silicon oxide from the silicon wafer while providing good protection for the silicon nitride in the silicon wafer, thereby maximally preserving the silicon nitride in the silicon wafer while removing the silicon oxide from the silicon wafer as far as possible, and in turn allowing the silicon wafer to be used well in the shallow trench isolation technology.

The effect that can be achieved by the polishing solution according to the present disclosure is attributed to that the sulfonic acid ligand can form a weak chemisorption with the silicon-oxygen bond (Si—O) through the strong polarity of the sulfonic acid ligand and can significantly enhance the interaction force of cerium oxide with the surface of silicon oxide (SiO₂), thereby greatly increasing the polishing rate of SiO₂ without damaging the silicon nitride film. Furthermore, the sulfonic acid ligand combined with cerium oxide increases the activity of the polishing solution on silicon oxide while reducing the chemical activity on silicon nitride, thereby achieving selective polishing well and preferentially removing silicon oxide from the silicon wafer. Furthermore, the sulfonic acid ligand is negatively charged, the combination of the sulfonic acid ligand with cerium oxide causes the surface of the cerium oxide particles to also be negatively charged, resulting in electrostatic repulsion of the cerium oxide particles with the likewise negatively charged silicon nitride surface, thereby reducing physical contact and damage to the silicon nitride. In addition, the introduction of the sulfonic acid ligand can also significantly increase the polishing rate of the polishing solution for silicon oxide. The chemical reactivity of cerium oxide is adjusted by the sulfonic acid ligand, so the corrosion rate of the cerium oxide is higher for silicon oxide but lower for silicon nitride, thereby balancing the polishing rate of the two, and further retaining silicon nitride in the silicon wafer. Furthermore, the polymeric chain or steric hindrance effect of the sulfonic acid groups can effectively stabilize the cerium oxide particles, prevent the agglomeration in the polishing solution, and ensure that the abrasives are uniformly dispersed and continuously act on the polishing surface, thereby effectively reducing local overpolishing or pitting defects due to particle agglomeration. Furthermore, the sulfonic acid groups enhance the chemical stability of cerium oxide through charge repulsion or hydrogen bonding, suppress the dissolution or passivation of cerium oxide particles during polishing, and prolong the service life of the abrasive.

In some embodiments, the ligand is a mixture of the L-camphorsulfonic acid and the cyclohexane-2-sulfonic acid.

In some embodiments, a mass ratio of the L-camphorsulfonic acid to the cyclohexane-2-sulfonic acid is in a range of 1-5:2-3.

In some embodiments, the mass ratio of the L-camphorsulfonic acid to the cyclohexane-2-sulfonic acid is 2:3.

In the present disclosure, there is a limitation on the choice of the sulfonic acid ligand. When the sulfonic acid ligand is at least one selected from the group consisting of L-camphorsulfonic acid, o-toluenesulfonic acid, p-toluenesulfonic acid, and cyclohexane-2-sulfonic acid, preferably a mixture of the L-camphorsulfonic acid and the cyclohexane-2-sulfonic acid, an excellent effect can be achieved. This is because when a mixture of L-camphorsulfonic acid and cyclohexane-2-sulfonic acid is selected as the sulfonic acid ligand, the synergistic effect of the two enables a more uniform distribution of the sulfonic acid ligand on the surface of the cerium oxide, thereby enhancing the dispersibility. Furthermore, both the L-camphorsulfonic acid and the cyclohexane-2-sulfonic acid have negative charges on the surface thereof, and the use of a mixture can more effectively adjust the surface charge of the cerium oxide particles to enhance the electrostatic repulsion, preventing agglomeration, and the mixing of the two can improve the dispersibility of the cerium oxide particles in a polar solvent, making the resulting polishing solution more uniformly dispersed and enhancing the polishing effect of the polishing solution. Furthermore, the synergistic effect of the L-camphorsulfonic acid and the cyclohexane-2-sulfonic acid can better improve the surface properties of cerium oxide, and the mixing of L-camphorsulfonic acid and cyclohexane-2-sulfonic acid allows more precise adjustment of the chemical reactivity of cerium oxide and enables the cerium oxide to exhibit increased reactivity on silicon oxide but decreased reactivity on silicon nitride, thereby enabling the modified polishing solution to selectively remove silicon oxide, protect the silicon nitride and simultaneously significantly increase the dissolution rate of silicon oxide, promoting the efficient removal of silicon oxide from the silicon wafer while providing good protection for the silicon nitride in the silicon wafer, maximally preserving the silicon nitride in the silicon wafer while removing the silicon oxide from the silicon wafer as far as possible, and in turn allowing the silicon wafer to be used well in the shallow trench isolation technology. In addition, the inventors have found through a series of inventive efforts that when a mixture of L-camphorsulfonic acid and cyclohexane-2-sulfonic acid is selected as a sulfonic acid ligand and introduced on the surface of cerium oxide, the prepared polishing solution exhibits higher efficiency and better surface quality during polishing, and is especially suitable for shallow trench isolation technology.

In some embodiments of the present disclosure, there is a limitation on a mass ratio of the L-camphorsulfonic acid to the cyclohexane-2-sulfonic acid. When the mass ratio of the L-camphorsulfonic acid to the cyclohexane-2-sulfonic acid is in a range of 1-5:2-3, preferably 2:3, an excellent effect can be achieved. This is because the mass ratio of the two can influence the distribution density of the sulfonic acid ligand on the surface of cerium oxide, and a proportion in a suitable range can ensure the uniform distribution of the sulfonic acid ligand on the cerium oxide surface. Furthermore, the chiral structure of L-camphorsulfonic acid and the cyclic structure of cyclohexane-2-sulfonic acid can achieve good complementarity to optimize the surface modification effect. An excessively high or low mass ratio of the two can affect the surface modification effect and further affect the modification effect of cerium oxide, and furthermore, an appropriate ratio can enhance the selective removal of silicon oxide while protecting silicon nitride. Thus, an excessively high proportion of L-camphorsulfonic acid would lead to excessive charge density to affect the interaction of the polishing solution with the silicon wafer surface and weaken the protective effect on silicon nitride, influencing polishing effects; and an excessively high proportion of cyclohexane-2-sulfonic acid would reduce the chemical stability of the polishing solution, leading to precipitation and layering of the polishing solution, reducing the overall reactivity of the polishing solution, and thus affecting the polishing efficiency.

In some embodiments, a mass ratio of the cerium oxide abrasive to the sulfonic acid ligand is in a range of 50:1 to 130:1.

In some embodiments, the mass ratio of the cerium oxide abrasive to the sulfonic acid ligand is in a range of 50:1 to 100:1.

In some embodiments, the mass ratio of the cerium oxide abrasive to the sulfonic acid ligand is 50:1 or 70:1.

In some embodiments of the present disclosure, there is a limitation on a mass ratio of the cerium oxide abrasive to the sulfonic acid ligand. When the mass ratio of the cerium oxide abrasive to the sulfonic acid ligand is in a range of 50:1 to 130:1, preferably 50:1 to 100:1, more preferably 50:1 or 70:1, it can achieve an excellent effect. This is because the mass ratio of the cerium oxide abrasive to the sulfonic acid ligand has an important influence on the modification effect, which ratio determines the distribution density of the sulfonic acid ligand on the surface of the cerium oxide, the distribution uniformity, and the properties after modification. An appropriate mass ratio can ensure that the sulfonic acid ligand is uniformly distributed on the surface of the cerium oxide, avoiding localized over-concentration or oversparseness; an appropriate mass ratio can optimize the charges on the surface of the particles and enhance electrostatic repulsion, so as to improve dispersibility while improving the interaction with polished surfaces; and an appropriate mass ratio can balance chemical corrosion and mechanical grinding, improving polishing selectivity and efficiency. Therefore, an excessively high mass ratio, i.e., too much sulfonic acid ligand, may lead to multi-layer adsorption of the sulfonic acid ligand on the surface of cerium oxide, even causing agglomeration between ligand molecules; excessive sulfonic acid ligand may result in uneven charge distribution on the particle surface, affecting the interaction of the particles with the polishing surface; furthermore, excessive sulfonic acid ligands also lead to excessive chemical reactivity of cerium oxide and thus excessive chemical corrosion of the surface of the silicon wafer, influencing the polishing quality. Further, an excessively low mass ratio, i.e., too few sulfonic acid ligands, would lead to insufficient density distribution on the surface of the cerium oxide, which makes the sulfonic acid ligand impossible to effectively cover the surface of the cerium oxide, affecting the modification effect; and it also leads to insufficient chemical reactivity of the cerium oxide, affecting the polishing efficiency.

Furthermore, in the present disclosure, since the cerium oxide modified with a sulfonic acid ligand can achieve excellent dispersion performance in deionized water, the cerium oxide abrasive in the polishing solution can achieve better dispersion without addition of any additional auxiliary raw material such as a stabilizer, preventing the agglomeration in the polishing solution, ensuring that the abrasive is evenly dispersed and continuously act on the polishing surface, and thereby improving the polishing efficiency of the polishing solution.

The present disclosure further provides a method for preparing the modified cerium oxide polishing solution for the shallow trench isolation as described above, including the following steps:
sequentially adding cerium nitrate and ammonia water, magnetically stirring a resulting mixture for 24 h to 26 h, and then conducting a reaction at a high temperature and a high pressure for 8 h to 10 h, and then subjecting a resulting reaction product to centrifugation, washing, and freeze drying to obtain an intermediate;
calcining the intermediate at 600° C. for 8 h to obtain a cerium oxide abrasive; and
sequentially adding the cerium oxide abrasive, the sulfonic acid ligand, and the deionized water, and mixing and stirring a resulting system until uniform, and then subjecting a resulting mixed product to ultrasonic dispersion to obtain the modified cerium oxide polishing solution for the shallow trench isolation.

In some embodiments, the high temperature is in a range of 120° C. to 150° C., and the high pressure is in a range of 3 MPa to 3.5 MPa.

In the method of the present disclosure, the surface chemical properties and reactivity of cerium oxide are significantly improved by the directional modification by the sulfonic acid groups without addition of any auxiliary raw material such as a stabilizer, thus enabling the cerium oxide to exhibit a stronger targeted adsorption capacity to silicon oxide during CMP, thereby achieving an efficient removal rate of silicon oxide while maintaining low damage to the silicon nitride film and ultimately effectively improving the polishing efficiency. The sulfonic acid groups form a stable sterically hindered layer on the surface of cerium oxide through the charge repulsion effect, significantly reduce the interparticle van der Waals forces, effectively suppress agglomeration, and promote the formation of a uniform dispersion of the cerium oxide abrasive in the polishing solution, thereby improving the selectivity ratio of silicon oxide to silicon nitride. The highly polar hydroxyl introduced by the sulfonic acid groups enhance the hydrophilicity of the particle surface, significantly increase the Zeta potential of the dispersion system by forming a dynamic hydration membrane, effectively retard particle settling, and further prolong the suspension stability duration by steric hindrance protection at the same time, ensuring consistently efficient polishing performance.

Compared with the conventional technology, some embodiments of the present disclosure have the following beneficial effects:
(1) The present disclosure provides a modified cerium oxide polishing solution for shallow trench isolation. The modified cerium oxide polishing solution includes cerium oxide modified with a sulfonic acid ligand, and the cerium oxide modified with the sulfonic acid ligand can excellently protect the silicon nitride in the silicon wafer during the polishing process and allow the silicon nitride to retain as much as possible in the silicon wafer while the silicon oxide contained in the silicon wafer is removed, thus enabling the modified cerium oxide polishing solution to have an improved selectivity ratio of the silicon oxide layer to the silicon nitride layer. In addition, the introduction of the sulfonic acid ligand can enhance the dispersion of cerium oxide particles in the solution, so that the modified cerium oxide polishing solution without adding a stabilizer can prevent agglomeration and thus ensure the uniform distribution of the polishing solution, improve the polishing effect.
(2) The present disclosure provides a method for preparing the modified cerium oxide polishing solution for the shallow trench isolation as described above. The modified cerium oxide polishing solution prepared by the method exhibits high stability and is suitable for the polishing treatment of high-precision elements such as semiconductors or optical elements. Furthermore, the preparation process is straightforward and reduces the use of hazardous chemicals simultaneously, thereby minimizing environmental pollution.

### BRIEF DESCRIPTION OF THE DRAWINGS

Various other advantages and benefits will become apparent to those of ordinary skill in the art upon reading the following detailed description of the preferred embodiments. The accompanying drawings are provided solely to illustrate preferred embodiments and are not to be construed as limiting the present disclosure. Throughout the drawings, the same reference symbols are used to denote the same components.

FIG. 1 shows a dynamic light scattering profile of a modified cerium oxide polishing solution for shallow trench isolation according to an embodiment of the present disclosure;

FIG. 2 shows Zeta potential curves of a modified cerium oxide polishing solution for shallow trench isolation according to an embodiment of the present disclosure;

FIG. 3 shows an SEM (scanning electron microscope) image of cerium oxide abrasive of a modified cerium oxide polishing solution for shallow trench isolation according to an embodiment of the present disclosure;

FIG. 4 shows an SEM image of modified cerium oxide abrasive of a modified cerium oxide polishing solution for shallow trench isolation according to an embodiment of the present disclosure;

FIG. 5 shows an infrared spectrum of a modified cerium oxide polishing solution for shallow trench isolation according to an embodiment of the present disclosure;

FIG. 6 shows an X-ray diffraction spectrum of a modified cerium oxide polishing solution for shallow trench isolation according to an embodiment of the present disclosure; and

FIG. 7 is a picture showing the dispersibility of a modified cerium oxide polishing solution for shallow trench isolation according to an embodiment of the present disclosure.

### DETAILED DESCRIPTION OF THE EMBODIMENTS

The technical solutions of the present disclosure will be clearly and completely described below in combination with the following specific embodiments. However, a person skilled in the art will understand that the examples described below are some, rather than all of, the examples of the present disclosure, and are only intended to illustrate the present disclosure and should not be regarded as limiting the scope of the present disclosure. On the basis of the examples of the present disclosure, all other examples that can be obtained by those of ordinary skill in the art without inventive efforts shall fall within the scope of the present disclosure.

To provide clearer elucidation of the technical solutions in the present disclosure, the following descriptions are presented in the form of specific examples.

### Example 1

### Step I: Preparation of Cerium Oxide Abrasive

Cerium nitrate was dissolved in deionized water, magnetically stirred for 24 h until the cerium nitrate was fully dissolved and then transferred to a peristaltic pump, and ammonia water was slowly added thereto. A resulting solution was transferred to a hydrothermal reactor, sealed, and then reacted at 120° C. and 3 MPa for 8 h. After reaction was completed, a resulting solution was centrifuged, and then washed and freeze dried to obtain an intermediate. The intermediate was then calcined at 600° C. for 8 h to obtain the cerium oxide abrasive.

### Step II: Preparation of Modified Cerium Oxide Abrasive

Subsequently, the cerium oxide abrasive and L-camphorsulfonic acid were sequentially added, with a mass ratio of the cerium oxide abrasive to a sulfonic acid ligand being 50:1, and a resulting mixture was reacted for 8 h to obtain the modified cerium oxide abrasive.

### Step III: Preparation of Polishing Solution

2 g of the modified cerium oxide abrasive above and 98 g of deionized water were mixed and stirred until uniform, and a resulting mixture was subjected to ultrasonic dispersion to obtain the polishing solution.

### Example 2

### Step I: Preparation of Cerium Oxide Abrasive

Cerium nitrate was dissolved in deionized water, magnetically stirred for 26 h until the cerium nitrate was fully dissolved and then transferred to a peristaltic pump, and ammonia water was slowly added thereto. A resulting solution was transferred to a hydrothermal reactor, sealed, and then reacted at 150° C. and 3.5 MPa for 10 h. After reaction was completed, a resulting solution was centrifuged, and then washed and freeze dried to obtain an intermediate. The intermediate was then calcined at 600° C. for 8 h to obtain the cerium oxide abrasive.

### Step II: Preparation of Modified Cerium Oxide Abrasive

Subsequently, the cerium oxide abrasive and L-camphorsulfonic acid were sequentially added, with a mass ratio of the cerium oxide abrasive to a sulfonic acid ligand being 130:1, and a resulting mixture was reacted for 8 h to obtain the modified cerium oxide abrasive.

### Step III: Preparation of Polishing Solution

5 g of the modified cerium oxide abrasive above and 95 g of deionized water were mixed and stirred until uniform, and then a resulting mixture was subjected to ultrasonic dispersion to obtain the polishing solution.

### Example 3

### Step I: Preparation of Cerium Oxide Abrasive

Cerium nitrate was dissolved in deionized water, magnetically stirred for 25 h until the cerium nitrate was fully dissolved and then transferred to a peristaltic pump, and ammonia water was slowly added thereto. A resulting solution was transferred to a hydrothermal reactor, sealed, and then reacted at 120° C. and 3.5 MPa for 8 h. After reaction was completed, a resulting solution was centrifuged, and then washed and freeze dried to obtain an intermediate. The intermediate was then calcined at 600° C. for 8 h to obtain the cerium oxide abrasive.

### Step II: Preparation of Modified Cerium Oxide Abrasive

Subsequently, cerium oxide and a sulfonic acid ligand were added, with a mass ratio of cerium oxide to the sulfonic acid ligand being 70:1, and a resulting mixture was reacted for 8 h to obtain the modified cerium oxide abrasive, where the sulfonic acid ligand was obtained by mixing L-camphorsulfonic acid and cyclohexane-2-sulfonic acid in a mass ratio of 2:3.

### Step III: Preparation of Polishing Solution

5 g of the modified cerium oxide abrasive above and 95 g of deionized water were mixed and stirred until uniform, and then a resulting mixture was subjected to ultrasonic dispersion to obtain the polishing solution.

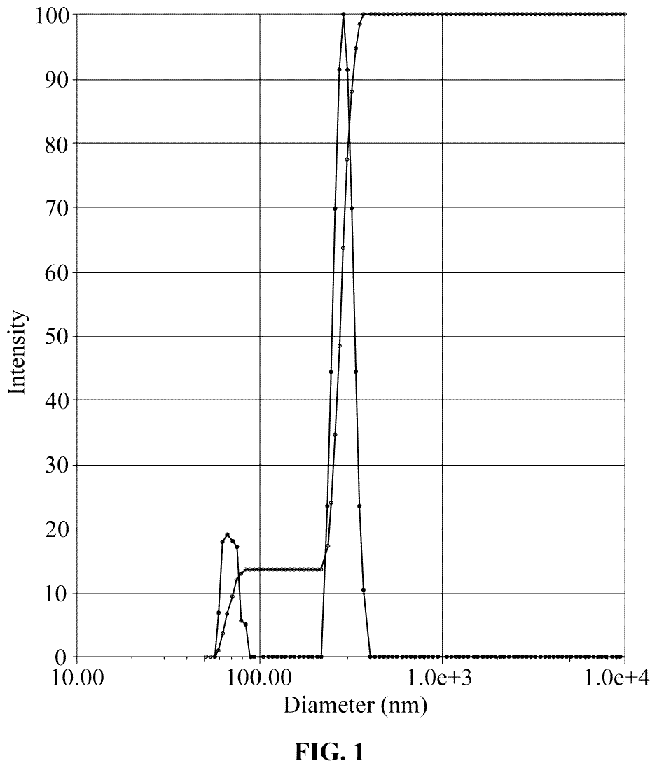

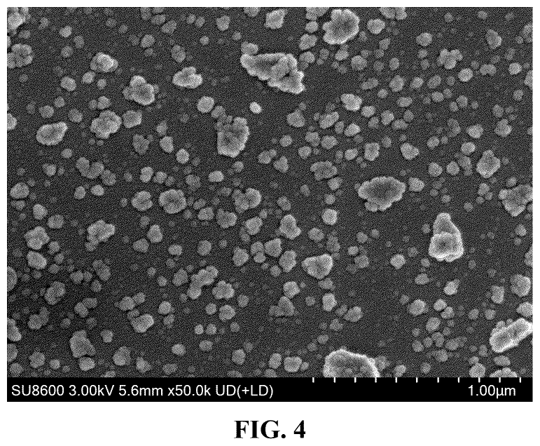

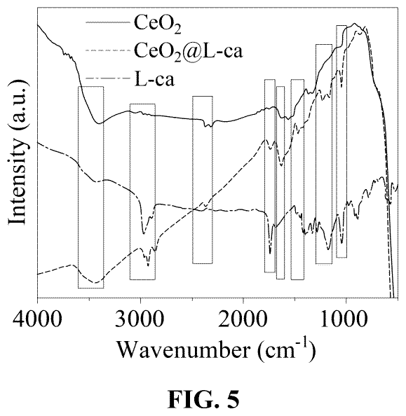

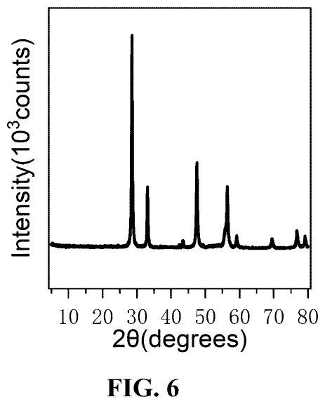

The polishing solution obtained in this example was then tested. The test results are shown in FIGS. 1 to 7, which show a dynamic light scattering profile, Zeta potential curves, a full-spectrum distribution image, an S spectrum distribution map, a Ce spectrum distribution map, an X-ray diffraction spectrum, and a dispersibility contrast picture of the polishing solution, respectively.

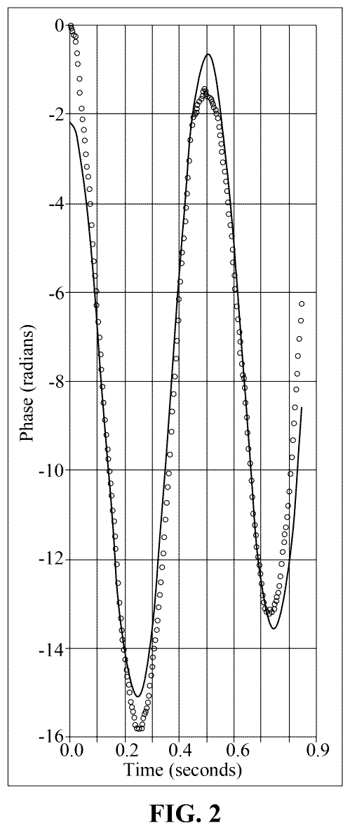

It is evident from FIG. 1 and FIG. 2 that after modifying cerium oxide with a sulfonic acid ligand, the modified cerium oxide abrasive shows excellent dispersibility in deionized water. As can be seen from FIG. 1, compared with the particle size of unmodified cerium oxide, the cerium oxide modified with a sulfonic acid ligand of the present disclosure has a significantly decreased particle size in deionized water, and as can be seen from FIG. 2, the potential of the cerium oxide modified with a sulfonic acid ligand is significantly increased, indicating that the modified cerium oxide can be uniformly dispersed in deionized water to continuously act on the polishing surface.

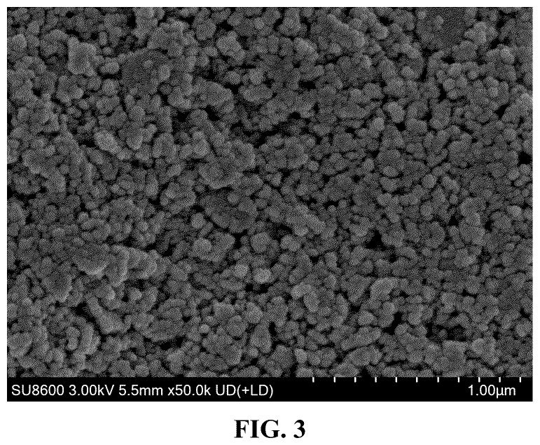

As can be seen from FIGS. 3 to 6, the cerium oxide itself is not structurally varied during the modification of the cerium oxide by the sulfonic acid ligand, and the modification of cerium oxide is primarily achieved through charge-directed adsorption to bind the sulfonic acid ligand with cerium oxide.

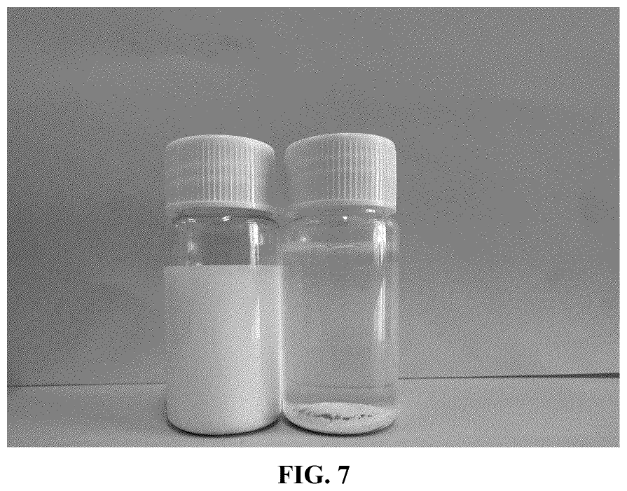

In FIG. 7, when comparing the polishing solution obtained in Example 3 with the polishing solution prepared by using an unmodified cerium oxide, the modified cerium oxide abrasive obtained in the present disclosure exhibits excellent dispersibility in deionized water.

### Experimental Example 1 Effect of Sulfonic Acid Ligand Selection on Polishing Solution Performance

The specific procedure steps were the same as those in Example 1, except that the type of the sulfonic acid ligand was changed.

A control group and experimental groups 1 to 8 were set up, respectively, where the control group was a polishing solution sample obtained by using cerium oxide unmodified by a sulfonic acid ligand.

The sulfonic acid ligand used in experimental group 1 was L-camphorsulfonic acid.

The sulfonic acid ligand used in experimental group 2 was o-toluenesulfonic acid.

The sulfonic acid ligand used in experimental group 3 was p-toluenesulfonic acid.

The sulfonic acid ligand used in experimental group 4 was cyclohexane-2-sulfonic acid.

The sulfonic acid ligand used in experimental group 5 was a mixture of L-camphorsulfonic acid and o-toluenesulfonic acid.

The sulfonic acid ligand used in experimental group 6 was a mixture of o-toluenesulfonic acid and p-toluenesulfonic acid.

The sulfonic acid ligand used in experimental group 7 was a mixture of p-toluenesulfonic acid and cyclohexane-2-sulfonic acid.

The sulfonic acid ligand used in experimental group 8 was a mixture of L-camphorsulfonic acid and cyclohexane-2-sulfonic acid.

Then, the polishing solutions obtained from the control group and the experimental groups 1 to 8 were applied to chemical mechanical polishing of wafers containing silicon oxide and silicon nitride by using a CMP polishing table with the same parameters. The final experimental results are shown in Table 1 below.

TABLE 1
Effect of different sulfonic acid ligands on
polishing performance of polishing solutions

| | SiO₂ | Si₃N₄ | Selectivity |
|---|---|---|---|
| Group No. | (Å/min) | (Å/min) | ratio |
| Control group | 4,350 | 825 | 5.3:1 |
| Experimental group 1 | 2,160 | 56 | 38.6:1 |
| Experimental group 2 | 3,980 | 225 | 17.7:1 |
| Experimental group 3 | 4,650 | 713 | 6.5:1 |
| Experimental group 4 | 3,120 | 125 | 25.0:1 |
| Experimental group 5 | 1,450 | 82 | 17.7:1 |
| Experimental group 6 | 3,240 | 63 | 51.4:1 |
| Experimental group 7 | 2,560 | 69 | 37.1:1 |
| Experimental group 8 | 1,820 | 32 | 56.9:1. |

As can be seen from the table above, the polishing solutions prepared after modification of cerium oxide by introducing sulfonic acid ligands have superior performance because the sulfonic acid ligands can form a weak chemisorption with the silicon-oxygen bond (Si—O) through the strong polarity thereof and can significantly enhance the interaction force of cerium oxide with the surface of silicon oxide (SiO₂), thereby greatly increasing the polishing rate of SiO₂ without damaging the silicon nitride film. Furthermore, the sulfonic acid ligand combined with cerium oxide increases the activity of the polishing solution on silicon oxide while reducing the chemical activity on silicon nitride, thereby achieving selective polishing well and preferentially removing silicon oxide from the silicon wafer. Furthermore, the sulfonic acid ligand is negatively charged, the combination of the sulfonic acid ligand with cerium oxide causes the surface of the cerium oxide particles to also be negatively charged, resulting in electrostatic repulsion of the cerium oxide particles with the likewise negatively charged silicon nitride surface, thereby reducing physical contact and damage to the silicon nitride. In addition, the introduction of the sulfonic acid ligand can also significantly increase the polishing rate of the polishing solution for silicon oxide. The chemical reactivity of cerium oxide is adjusted by the sulfonic acid ligand, so the corrosion rate of the cerium oxide is higher for silicon oxide but lower for silicon nitride, thereby balancing the polishing rate of the two, and further retaining silicon nitride in the silicon wafer. Furthermore, the polymeric chain or steric hindrance effect of the sulfonic acid groups can effectively stabilize the cerium oxide particles, prevent agglomeration in the polishing solution, and ensure that the abrasives are uniformly dispersed and continuously act on the polishing surface, thereby effectively reducing local overpolishing or pitting defects due to particle agglomeration. Furthermore, the sulfonic acid groups enhance the chemical stability of cerium oxide through charge repulsion or hydrogen bonding, suppress the dissolution or passivation of cerium oxide particles during polishing, and prolong the service life of the abrasive.

For the present disclosure, the choice of the sulfonic acid ligand is limited. When the sulfonic acid ligand is at least one selected from the group consisting of L-camphorsulfonic acid, o-toluenesulfonic acid, p-toluenesulfonic acid, and cyclohexane-2-sulfonic acid, preferably a mixture of the L-camphorsulfonic acid and the cyclohexane-2-sulfonic acid, an excellent effect can be achieved. This is because when a mixture of L-camphorsulfonic acid and cyclohexane-2-sulfonic acid is selected as the sulfonic acid ligand, the synergistic effect of the two enables a more uniform distribution of the sulfonic acid ligand on the surface of the cerium oxide, thereby enhancing the dispersibility; furthermore, both the L-camphorsulfonic acid and the cyclohexane-2-sulfonic acid have negative charges on the surface, and the use of a mixture can more effectively adjust the surface charge of the cerium oxide particles to enhance the electrostatic repulsion, preventing agglomeration, and the mixing of the two can improve the dispersibility of the cerium oxide particles in a polar solvent, making the resulting polishing solution more uniformly dispersed and enhancing the polishing effect of the polishing solution. Furthermore, the synergistic effect of the L-camphorsulfonic acid and the cyclohexane-2-sulfonic acid can better improve the surface properties of cerium oxide, and the mixing of L-camphorsulfonic acid and cyclohexane-2-sulfonic acid allows more precise adjustment of the chemical reactivity of cerium oxide and enables the cerium oxide to exhibit increased reactivity on silicon oxide but decreased reactivity on silicon nitride, thereby enabling the modified polishing solution to selectively remove silicon oxide, protect the silicon nitride and simultaneously significantly increase the dissolution rate of silicon oxide, promoting the efficient removal of silicon oxide from the silicon wafer while providing good protection for the silicon nitride in the silicon wafer, maximally preserving the silicon nitride in the silicon wafer while removing the silicon oxide from the silicon wafer as far as possible, and in turn allowing the silicon wafer to be used well in the shallow trench isolation technology. In addition, the inventors have found through a series of inventive efforts that when a mixture of L-camphorsulfonic acid and cyclohexane-2-sulfonic acid is selected as a sulfonic acid ligand and introduced on the surface of cerium oxide, the prepared polishing solution exhibits higher efficiency and better surface quality during polishing, and is especially suitable for shallow trench isolation technology.

### Experimental Example 2: Exploration of Mass Ratio of L-Camphorsulfonic Acid and Cyclohexane-2-Sulfonic Acid

Experimental group 8 in experimental example 1 was selected for refinement, and experimental groups 9 to 16 were set up, respectively.

The mass ratio of L-camphorsulfonic acid to cyclohexane-2-sulfonic acid was 1:9 in Experimental group 9.

The mass ratio of L-camphorsulfonic acid to cyclohexane-2-sulfonic acid was 1:7 in Experimental group 10.

The mass ratio of L-camphorsulfonic acid to cyclohexane-2-sulfonic acid was 1:5 in Experimental group 11.

The mass ratio of L-camphorsulfonic acid to cyclohexane-2-sulfonic acid was 1:4 in Experimental group 12.

The mass ratio of L-camphorsulfonic acid to cyclohexane-2-sulfonic acid was 1:2 in Experimental group 13.

The mass ratio of L-camphorsulfonic acid to cyclohexane-2-sulfonic acid was 2:3 in Experimental group 14.

The mass ratio of L-camphorsulfonic acid to cyclohexane-2-sulfonic acid was 4:5 in Experimental group 15.

The mass ratio of L-camphorsulfonic acid to cyclohexane-2-sulfonic acid was 1:1 in Experimental group 16.

Then, the polishing solutions obtained from the control group and the experimental groups 9 to 16 were applied to chemical mechanical polishing of wafers containing silicon oxide and silicon nitride by using a CMP polishing table with the same parameters. The final experimental results are shown in Table 2 below.

TABLE 2
Effect of different mass ratios of sulfonic acid ligand
on polishing performance of polishing solutions

| | SiO₂ | Si₃N₄ | Selectivity |
|---|---|---|---|
| Group No. | (Å/min) | (Å/min) | ratio |
| Experimental group 9 | 1,610 | 82 | 19.6:1 |
| Experimental group 10 | 1,520 | 87 | 17.5:1 |
| Experimental group 11 | 1,790 | 43 | 41.6:1 |
| Experimental group 12 | 1,820 | 41 | 44.4:1 |
| Experimental group 13 | 1,510 | 32 | 47.1:1 |
| Experimental group 14 | 1,840 | 34 | 54.1:1 |
| Experimental group 15 | 1,820 | 52 | 32.0:1 |
| Experimental group 16 | 1,730 | 51 | 34.0:1. |

As can be seen from the data in the table above, when the sulfonic acid ligand is selected as a mixture of L-camphorsulfonic acid and cyclohexane-2-sulfonic acid, the mass ratio of the two is very important. When the mass ratio of the L-camphorsulfonic acid to the cyclohexane-2-sulfonic acid is in a range of 1-5:2-3, preferably 2:3, it can achieve an excellent effect. This is because the mass ratio of the two can influence the distribution density of the sulfonic acid ligand on the surface of cerium oxide, and a proportion in a suitable range can ensure the uniform distribution of the sulfonic acid ligand on the cerium oxide surface; furthermore, the chiral structure of L-camphorsulfonic acid and the cyclic structure of cyclohexane-2-sulfonic acid can achieve good complementarity to optimize the surface modification effect. An excessively high or low mass ratio of the two can affect the surface modification effect and further affect the modification effect of cerium oxide, and furthermore, an appropriate ratio can enhance the selective removal of silicon oxide while protecting silicon nitride. Thus, an excessively high proportion of L-camphorsulfonic acid would lead to excessive charge density to affect the interaction of the polishing solution with the silicon wafer surface and weaken the protective effect on silicon nitride, influencing polishing effects; and an excessively high proportion of cyclohexane-2-sulfonic acid would reduce the chemical stability of the polishing solution, leading to precipitation and layering of the polishing solution, reducing the overall reactivity of the polishing solution, and thus affecting the polishing efficiency.

### Experimental Example 3: Exploration of Mass Ratio of Sulfonic Acid Ligand to Cerium Oxide

Experimental group 14 in experimental example 2 was selected for refinement, where experimental group 14 was a control group, with the mass of cerium oxide in Example 14 being 20 g, and experimental groups 17 to 24 were set.

The mass ratio of cerium oxide to the sulfonic acid ligand was 30:1 in experimental group 17.

The mass ratio of cerium oxide to the sulfonic acid ligand was 40:1 in experimental group 18.

The mass ratio of cerium oxide to the sulfonic acid ligand was 50:1 in experimental group 19.

The mass ratio of cerium oxide to the sulfonic acid ligand was 70:1 in experimental group 20.

The mass ratio of cerium oxide to the sulfonic acid ligand was 100:1 in experimental group 21.

The mass ratio of cerium oxide to the sulfonic acid ligand was 120:1 in experimental group 22.

The mass ratio of cerium oxide to the sulfonic acid ligand was 130:1 in experimental group 23.

The mass ratio of cerium oxide to the sulfonic acid ligand was 150:1 in experimental group 24.

Then, the polishing solutions obtained were applied to chemical mechanical polishing of silicon oxide and silicon nitride wafers by using a CMP polishing table with the same parameters. The experimental results are shown in Table 3.

TABLE 3
Effect of different mass ratios of cerium oxide
to sulfonic acid ligand on polishing performance

| | MSA | SiO₂ | Si₃N₄ | Selectivity |
|---|---|---|---|---|
| | (g) | (Å/min) | (Å/min) | ratio |
| Control group | 0.39 | 1,840 | 34 | 54.1:1 |
| Experimental group 17 | 0.65 | 670 | 34 | 19.7:1 |
| Experimental group 18 | 0.49 | 820 | 30 | 22.7:1 |
| Experimental group 19 | 0.39 | 1,620 | 32 | 50.6:1 |
| Experimental group 20 | 0.28 | 1,780 | 30 | 59.3:1 |
| Experimental group 21 | 0.20 | 2,130 | 52 | 41.0:1 |
| Experimental group 22 | 0.17 | 2,190 | 56 | 39.1:1 |
| Experimental group 23 | 0.15 | 2,780 | 210 | 13.2:1 |
| Experimental group 24 | 0.13 | 2,820 | 230 | 12.7:1. |

As can be seen from the table above, the mass ratio of the cerium oxide to the sulfonic acid ligand is limited. When the mass ratio of the cerium oxide to the sulfonic acid ligand is in a range of 50:1 to 130:1, preferably 50:1 to 100:1, more preferably 50:1 or 70:1, it can achieve an excellent effect. This is because the mass ratio of the cerium oxide to the sulfonic acid ligand has an important influence on the modification effect, which ratio determines the distribution density of the sulfonic acid ligand on the surface of the cerium oxide, the distribution uniformity, and the properties after modification. An appropriate mass ratio can ensure that the sulfonic acid ligand is uniformly distributed on the surface of the cerium oxide, avoiding localized over-concentration or oversparseness; an appropriate mass ratio can optimize the charges on the surface of the particles and enhance electrostatic repulsion, so as to improve dispersibility while improving the interaction with polished surfaces; and an appropriate mass ratio can balance chemical corrosion and mechanical grinding, improving polishing selectivity and efficiency. Therefore, an excessively high mass ratio, i.e., too much sulfonic acid ligand, may lead to multi-layer adsorption of the sulfonic acid ligand on the surface of cerium oxide, even causing agglomeration between ligand molecules; excessive sulfonic acid ligand may result in uneven charge distribution on the particle surface, affecting the interaction of the particles with the polishing surface; furthermore, excessive sulfonic acid ligands also lead to excessive chemical reactivity of cerium oxide and thus excessive chemical corrosion of the surface of the silicon wafer, influencing the polishing quality. Further, an excessively low mass ratio, i.e., too few sulfonic acid ligand, would lead to insufficient density distribution on the surface of the cerium oxide, which makes the sulfonic acid ligand impossible to effectively cover the surface of the cerium oxide, affecting the modification effect; it also leads to insufficient chemical reactivity of the cerium oxide, affecting the polishing efficiency.

It should be finally noted that the foregoing embodiments are merely used for illustrating, rather than limiting, the technical solutions of the present disclosure. Although the disclosure has been described in details with reference to the foregoing embodiments, those of ordinary skill in the art should understand that the technical solutions described in the foregoing embodiments may still be modified, or some or all of the technical features thereof may be equivalently substituted; and the modifications or substitutions do not make the essence of the corresponding technical solutions depart from the scope of the technical solutions in the embodiments of the disclosure.

What is claimed is:

1. A modified cerium oxide polishing solution for shallow trench isolation, mainly being prepared from, in percentages by mass, the following raw materials:
2% to 5% of a modified cerium oxide abrasive; and
95% to 98% of deionized water, wherein
the modified cerium oxide abrasive comprises a cerium oxide abrasive and a sulfonic acid ligand; and
the sulfonic acid ligand is at least one selected from the group consisting of L-camphorsulfonic acid, o-toluenesulfonic acid, p-toluenesulfonic acid, and cyclohexane-2-sulfonic acid.

2. The modified cerium oxide polishing solution for the shallow trench isolation of claim 1, wherein the sulfonic acid ligand is a mixture of the L-camphorsulfonic acid and the cyclohexane-2-sulfonic acid.

3. The modified cerium oxide polishing solution for the shallow trench isolation of claim 2, wherein a mass ratio of the L-camphorsulfonic acid to the cyclohexane-2-sulfonic acid is in a range of 1-5:2-3.

4. The modified cerium oxide polishing solution for the shallow trench isolation of claim 3, wherein the mass ratio of the L-camphorsulfonic acid to the cyclohexane-2-sulfonic acid is 2:3.

5. The modified cerium oxide polishing solution for the shallow trench isolation of claim 1, wherein a mass ratio of the cerium oxide abrasive to the sulfonic acid ligand is in a range of 50:1 to 130:1.

6. The modified cerium oxide polishing solution for the shallow trench isolation of claim 5, wherein the mass ratio of the cerium oxide abrasive to the sulfonic acid ligand is in a range of 50:1 to 100:1.

7. The modified cerium oxide polishing solution for the shallow trench isolation of claim 6, wherein the mass ratio of the cerium oxide abrasive to the sulfonic acid ligand is 50:1 or 70:1.

8. A method for preparing the modified cerium oxide polishing solution for the shallow trench isolation of claim 1, comprising the following steps:
sequentially adding cerium nitrate and ammonia water, magnetically stirring a resulting mixture for 24 hours to 26 hours, and then conducting a reaction at a high temperature and a high pressure for 8 hours to 10 hours, and subjecting a resulting reaction product to centrifugation, washing, and freeze drying in sequence to obtain an intermediate;
calcining the intermediate at 600° C. for 8 hours to obtain the cerium oxide abrasive; and
sequentially adding the cerium oxide abrasive, the sulfonic acid ligand, and the deionized water, and mixing and stirring a resulting system, subjecting a resulting mixed material to ultrasonic dispersion to obtain the modified cerium oxide polishing solution for the shallow trench isolation.

9. The method of claim 8, wherein the high temperature is in a range of 120° C. to 150° C., and the high pressure is in a range of 3 MPa to 3.5 MPa.

10. The method of claim 8, wherein the sulfonic acid ligand is a mixture of the L-camphorsulfonic acid and the cyclohexane-2-sulfonic acid.

11. The method of claim 10, wherein a mass ratio of the L-camphorsulfonic acid to the cyclohexane-2-sulfonic acid is in a range of 1-5:2-3.

12. The method of claim 11, wherein the mass ratio of the L-camphorsulfonic acid to the cyclohexane-2-sulfonic acid is 2:3.

13. The method of claim 8, wherein a mass ratio of the cerium oxide abrasive to the sulfonic acid ligand is in a range of 50:1 to 130:1.

14. The method of claim 13, wherein the mass ratio of the cerium oxide abrasive to the sulfonic acid ligand is in a range of 50:1 to 100:1.

15. The method of claim 14, wherein the mass ratio of the cerium oxide abrasive to the sulfonic acid ligand is 50:1 or 70:1.
